(19) United States
(12) Patent Application Publication
(10) Pub. No.: US 2013/0024761 A1
(43) Pub. Date: Jan. 24, 2013

(54) SEMANTIC TAGGING OF USER-GENERATED CONTENT

(71) Applicants: Nick Bartomeli, Shelton, CT (US); John Hack, Maplewood, NJ (US)

(72) Inventors: Nick Bartomeli, Shelton, CT (US); John Hack, Maplewood, NJ (US)

(21) Appl. No.: 13/184,996

(22) Filed: Jul. 18, 2011

(51) Int. Cl. G06F 17/20

(52) U.S. Cl. 715/230

(57) ABSTRACT

A system includes presentation, within an application process, of data associated with a data space, reception of an annotation from a user during presentation of the data within the application process, and storage of the annotation in association with one or more semantic tags indicating the data space and the application process. The annotation may be indexed based on the one or more semantic tags for later retrieval.

### BACKGROUND

Conventional computing systems generate vast amounts of electronic data. Accordingly, many techniques have been developed to organize electronic data in a useful manner. These techniques typically attempt to organize data to facilitate access, manipulation, and/or searching thereof.

“Tags” (i.e., metadata) may be associated with data to assist searching of the data. In the case of data generated by an application (e.g., a sales report), the application may assign tags to the data based on the parameter values which were used to generate the data (e.g., Year 2010, New York Region, handbags). If a search query including one or more of these tags is subsequently received, the associated data (i.e., the sales report) is located based on the tags and returned within the corresponding search results. The data may also be indexed based on the tags to provide faster searching.

To be effective, the foregoing systems require consistency in the assignment of tags to data and in the tags themselves. This consistency may be provided automatically in the case of structured data, and in the case of data generated based on structured data, by simply using the underlying schema to determine the appropriate tags.

Tagging of user-generated data presents difficulties. For example, a user is typically unfamiliar with an underlying schema and/or with underlying assignment conventions, and is therefore unable to properly tag user-generated data. Accordingly, this data is typically stored without tags or with tags that are not consistent with the tags of other stored data. Consequently, the user-generated data is not as effectively-searchable as other system data.

### BRIEF DESCRIPTION OF THE DRAWINGS

FIG. 1 is a block diagram of a system according to some embodiments.

FIG. 2 is a flow diagram of a process according to some embodiments.

FIG. 3 is an outward view of a user interface according to some embodiments.

FIG. 4 is an outward view of a user interface according to some embodiments.

FIG. 5 is a data schema according to some embodiments.

FIG. 6 is a block diagram of a computing device according to some embodiments.

### DETAILED DESCRIPTION

The following description is provided to enable any person in the art to make and use the described embodiments and sets forth the best mode contemplated for carrying out some embodiments. Various modifications, however, will remain readily apparent to those in the art.

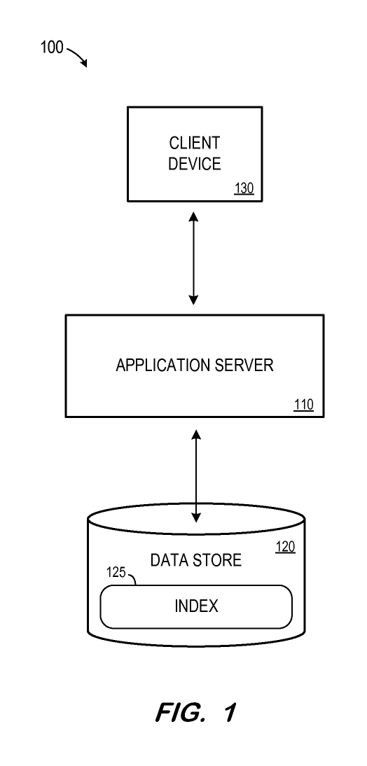

FIG. 1 is a block diagram of system 100 according to some embodiments. FIG. 1 represents a logical architecture for describing processes according to some embodiments, and actual implementations may include more or different components arranged in other manners. Other topologies may be used in conjunction with other embodiments. Moreover, each system described herein may be implemented by any number of computing devices in communication with one another via any number of other public and/or private networks. Two or more of such computing devices of may be located remote from one another and may communicate with one another via any known manner of network(s) and/or a dedicated connection. Each computing device may comprise any number of hardware and/or software elements suitable to provide the functions described herein as well as any other functions. For example, any computing device used in an implementation of system 100 may include a processor to execute program code such that the computing device operates as described herein.

All systems and processes discussed herein may be embodied in program code stored on one or more computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Application server 110 may provide functionality based on data of data store 120. Application server 110 may also provide business context and logic to assist with the interpretation of the data. In this regard, according to some embodiments, application server 110 may encapsulate the data into business objects including both data and related logic.

Application server 110 may provide business processes to clients as is known in the art. A business process may comprise software functionality for a target business segment. A business process may include, but is not limited to, functionality related to schedules, reports, ETL processes, management approvals, standard business practices (e.g., revenue forecasts by product line, costs by department), and security. Business processes may guide and coordinate end-users toward a common performance management goal, such as creating a compliant forecast or statutory-consolidated financial results. One or more business processes may be implemented as a Web Service and exposed via Web Services of application server 110. Embodiments may comprise any types of business processes, Web Services, and software-provided functions that are or becomes known.

Data store 120 may comprise a physical and/or an in-memory (e.g., in Random Access Memory) database, or any other type of data store that is or becomes known. A portion of the data stored in data store 120 may be associated with metadata, and this metadata may include tags or other semantic information. The data of data store 120 may be received from disparate hardware and software systems, some of which are not interoperational with one another. The systems may comprise a back-end data environment employed in a business or industrial context. The data may be pushed to data store 120 and/or provided in response to queries received therefrom.

Data store 120 may comprise a relational database, a multi-dimensional database, an eXtendable Markup Language (XML) document, or any other structured data storage system. The data of data store 120 may be distributed among several relational databases, dimensional databases, and/or other data sources. To provide economies of scale, data store 120 may include data of more than one customer. In such an implementation, application server 110 includes mechanisms to ensure that a client accesses only the data that the client is authorized to access. Moreover, the data of data store 120 may be indexed and/or selectively replicated in index 125 to allow fast retrieval thereof.

Client device 130 may present user interfaces to allow interaction with business applications executed by application server 110. Presentation of a user interface may comprise any degree or type of rendering, depending on the type of user interface code generated by server 110. For example, client device 130 may execute a Web Browser to receive a Web page (e.g., in HTML format) from application server 110, and may render and present the Web page according to known protocols. Client device 130 may also or alternatively present user interfaces by executing a standalone executable file (e.g., an .exe file) or code (e.g., a JAVA applet) within a virtual machine.

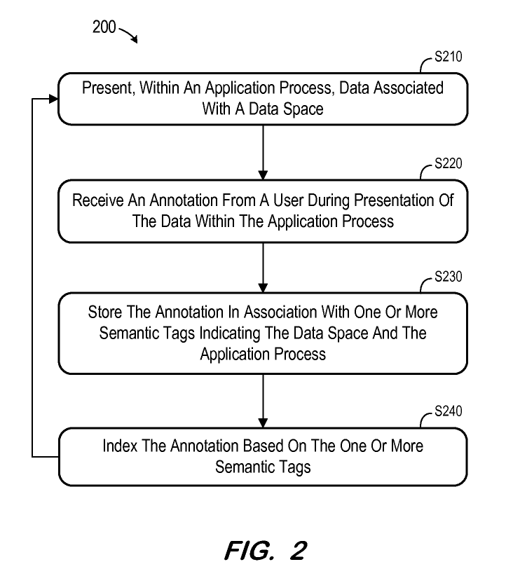

FIG. 2 comprises a flow diagram of process 200 according to some embodiments. In some embodiments, various hardware elements of application server 110 execute program code to perform process 200. Process 200 and all other processes mentioned herein may be embodied in computer-executable program code read from one or more of non-transitory computer-readable media, such as a floppy disk, a CD-ROM, a DVD-ROM, a Flash drive, and a magnetic tape, and then may be stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Data is presented at S210. The data is associated with a data space and is presented within an application process. A data space may refer to a set of data associated with particular dimension values, an Online Analytical Processing (OLAP) cube, or any other definable set of data. The data presented at S210 may be a subset of all data associated with the data space, and other data (i.e., data not associated with the data space) may be presented at S210 as well.

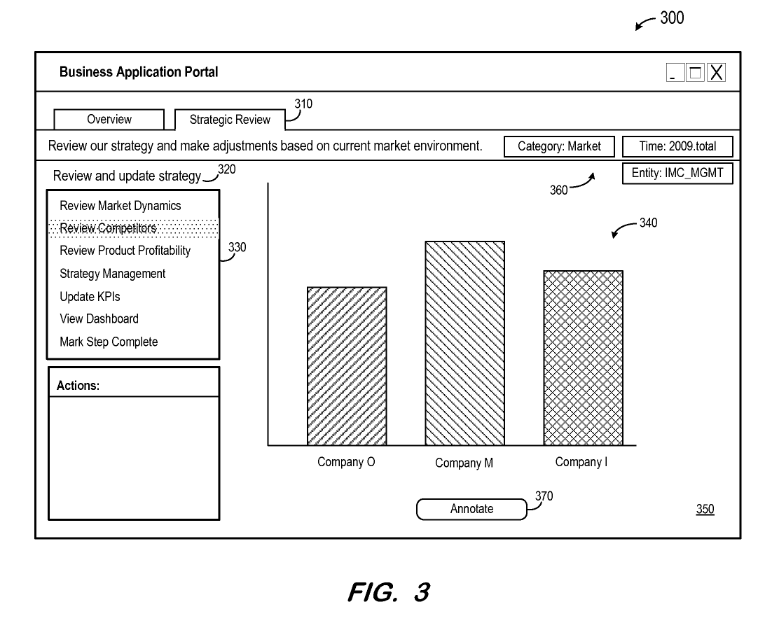

The application process of S210 may comprise a business process provided to client device 130 by application server 110. For example, a user may operate client device 130 to request a business process from application server 110. In response, client device 130 may receive and present a user interface such as user interface 300 of FIG. 3.

Interface 300 is presented as a “tabbed” Web page, with tab 310 showing the name of the requested application process. Text 320 identifies a step of the application process, while UI controls (e.g., hyperlinks) 330 are associated with sub-steps of step 320. One of the UI controls 330 (e.g., Review Competitors) has been selected, and corresponding data 340 is presented within area 350.

Data 340 may be presented in any suitable manner, including but not limited to tables, charts, graphs, etc. Data 340 is associated with a data space defined by dimension value controls 360. In some embodiments, the data space may be changed by selecting one or more of controls 360, which may or may not result in a change to presented data 340. Embodiments are not limited to the types of application processes or to the examples of data presentation described herein.

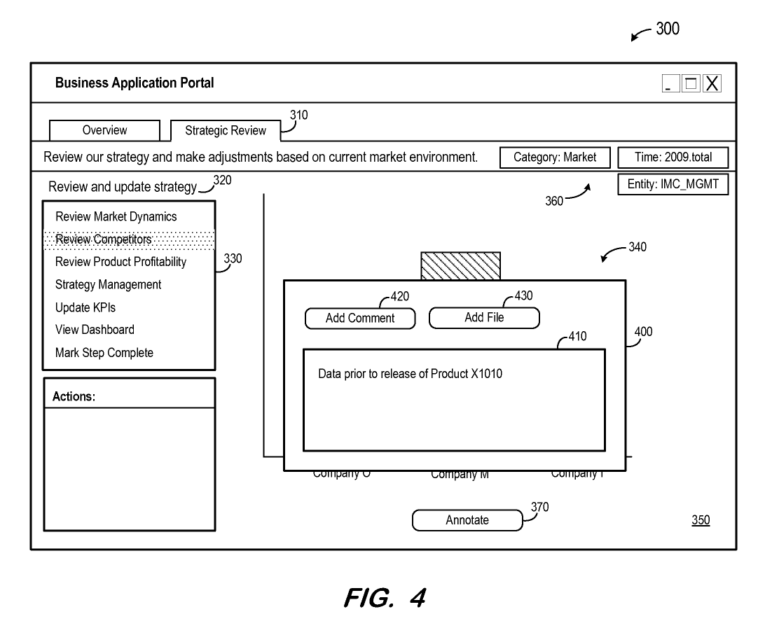

Next, at S220, an annotation is received from a user during presentation of the data within the application process. The annotation may include one or more of a text comment, an attachment (e.g., a document, a report, an analytical visualization), and/or other data. Returning to FIG. 3, a user may select Annotate control 370 prior to S220, resulting in presentation of dialog 400 of FIG. 4.

The user may manipulate dialog 400 to input an annotation. For example, the user may type a comment (as shown) into comment area 410 and select Add Comment control 420 to transmit the comment to application server 110. Additionally or alternatively, the user may select Add File control 430 to select a file (e.g., through a subsequently-presented file selection dialog) and transmit the selection to application server 110. The annotation (e.g., comment, file, and/or other data) may be semantically-related to both the application process and the data space of presented data 340.

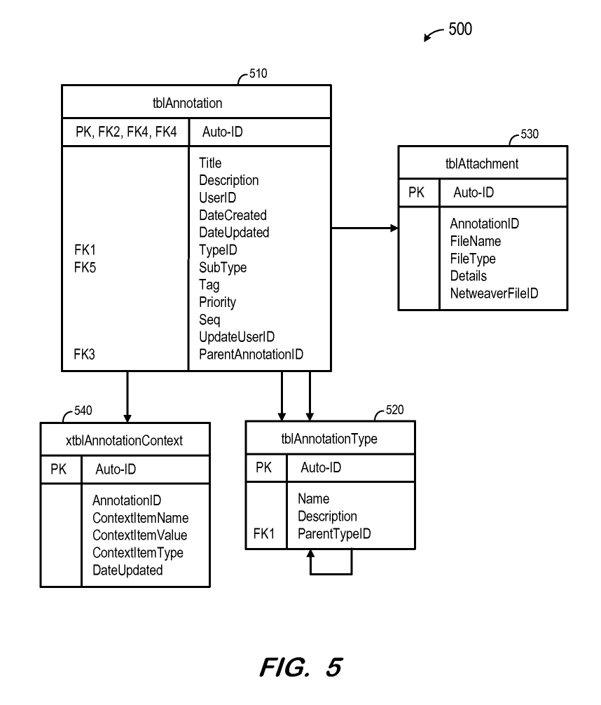

The received annotation is stored at 5230 in association with one or more semantic tags. The one or more semantic tags indicate the current data space and the current application process. FIG. 5 illustrates a schema for storing such tags in association with an annotation according to some embodiments.

Schema 500 includes table 510 to specify various field values of the annotation, table 520 to indicate a type of the annotation, and table 530 to define metadata associated with any file attachments of an annotation. In some embodiments the type in table 520 may be hierarchical (e.g., document >Word document).

Table 540 defines semantic tags to indicate a data space and an application process. These tags may be associated with an annotation such as a comment and/or an attachment represented by an instance of table 510. For example, with respect to the example of FIG. 4, S230 may comprise generation of an instance of table 540 including the following data:

### ContextItemName: Category

### ContextItemValue: Market

### ContextItemType: Dimension

Another instance may be created as follows,

### ContextItemName: Time

ContextItemValue: 2009.total

### ContextItemType: Dimension

and yet another instance as follows:

### ContextItemName: Entity

### ContextItemValue: IMC MGMT

### ContextItemType: Dimension

Moreover, the following semantic tags may be created to indicate the application process as follows:

### ContextItemName: Strategic Review

### ContextItemValue: Null

### ContextItemType: Process

The foregoing instances may be associated with a particular annotation through the annotation ID field of table 540.

As described above, a process may include steps and sub-steps. In this regard, table 540 may allow creation of corresponding semantic tags:

ContextItemName: Review and update strategy

### ContextItemValue: Null

ContextItemType: Process step
and

### ContextItemName: Review Competitors

### ContextItemValue: Null

ContextItemType: Process substep

By virtue of the foregoing, the structured data (e.g., tables, cubes), semi-structured data (e.g., comments) and unstructured data (e.g., files) of data store 120 may be associated with consistent semantic tags. Such association may facilitate analysis, searching, and aggregation of these various types of data.

According to the present embodiment, the stored annotation is indexed at S240 based on the one or more semantic tags. S240 may occur periodically, as it may be inefficient to re-generate index 125 each time a new annotation and its associated semantic tags are stored. As described above, this indexing allows for faster searching of data based on queries including the semantic tags.

Flow returns to S210 to repeat as described above. The application process and/or the data space may change during subsequent cycles of process 200. For example, if the user uses controls 360 to change the current data space, a subsequently-input annotation will be stored in association with semantic tags indicating the new data space and indicating the same application process. Conversely, if the user accesses the same data space in a new application process, an input annotation will be stored in association with semantic tags indicating the new application process and the same data space.

Process 200 may be executed for each user served by application server 110. Therefore, a second user may view data of a data space within an application process as shown in FIGS. 3 and 4. The second user may also input an annotation to be stored in association with semantic tags indicating the data space and the application process of FIGS. 3 and 4. In this regard, table 510 includes a User ID field to associate each annotation with its creator, but embodiments are not limited thereto.

As a result of process 200, annotations relevant to a user's current task may be efficiently located. For example, a user viewing data of a data space within an application may be selectively presented with annotations that are associated with semantic tags indicating the same data space and application process. The annotations may have been created by the user or by another user.

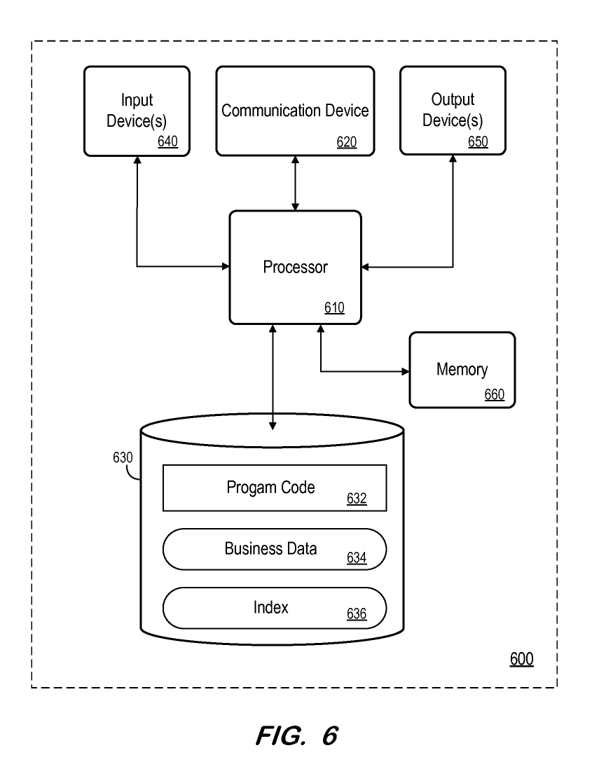

FIG. 6 is a block diagram of apparatus 600 according to some embodiments. Apparatus 600 may comprise a general-purpose computing apparatus and may execute program code to perform any of the functions described herein. Apparatus 600 may comprise an implementation of one or more elements of system 100. Apparatus 600 may include other unshown elements according to some embodiments.

Apparatus 600 includes processor 610 operatively coupled to communication device 620, data storage device 630, one or more input devices 640, one or more output devices 650 and memory 660. Communication device 620 may facilitate communication with external devices, such as client device 130. Input device(s) 640 may comprise, for example, a keyboard, a keypad, a mouse or other pointing device, a microphone, knob or a switch, an infra-red (IR) port, a docking station, and/or a touch screen. Input device(s) 640 may be used, for example, to enter information into apparatus 600. Output device(s) 650 may comprise, for example, a display (e.g., a display screen) a speaker, and/or a printer.

Data storage device 630 may comprise any appropriate persistent storage device, including combinations of magnetic storage devices (e.g., magnetic tape, hard disk drives and flash memory), optical storage devices, Read Only Memory (ROM) devices, etc., while memory 660 may comprise Random Access Memory (RAM).

Program code 632 of data storage device 630 may be executable by processor 610 to provide any of the processes described herein. Embodiments are not limited to execution of these processes by a single apparatus. Business data 634 may comprise any suitable data in any suitable format (e.g., row-based, columnar, object-based), while index 636 may comprise an inverted index of data 634. In some embodiments, index 636 indexes at least a portion of data 634 based on associated semantic tags as described herein. Data storage device 630 may also store data and other program code for providing additional functionality and/or which are necessary for operation thereof, such as device drivers, operating system files, etc.

The embodiments described herein are solely for the purpose of illustration. Those in the art will recognize other embodiments may be practiced with modifications and alterations limited only by the claims.

What is claimed is:

1. A method implemented by a computing system in response to execution of program code by a processor of the computing system, comprising:
presenting, within an application process, data associated with a data space;
receiving an annotation from a user during presentation of the data within the application process; and
storing the annotation in association with one or more semantic tags indicating the data space and the application process.

2. A method according to claim 1, further comprising:
indexing the annotation based on the one or more semantic tags.

3. A method according to claim 1, further comprising:
presenting, within a second application process, second data associated with a second data space;
receiving a second annotation from the user during presentation of the second data within the second application process;
storing the second annotation in association with a second one or more semantic tags indicating the second data space and the second application process;
indexing the annotation based on the one or more semantic tags; and
indexing the second annotation based on the second one or more semantic tags.

4. A method according to claim 1, further comprising:
presenting, within the application process, second data associated with a second data space;
receiving a second annotation from the user during presentation of the second data within the application process;
storing the second annotation in association with a second one or more semantic tags indicating the second data space and the application process;
indexing the annotation based on the one or more semantic tags; and
indexing the second annotation based on the second one or more semantic tags.

5. A method according to claim 1, further comprising:
presenting, within a second application process, second data associated with the data space;
receiving a second annotation from the user during presentation of the second data within the second application process;
storing the second annotation in association with a second one or more semantic tags indicating the data space and the second application process;
indexing the annotation based on the one or more semantic tags; and
indexing the second annotation based on the second one or more semantic tags.

6. A method according to claim 1, further comprising:
determining that second data associated with the data space is being presented to a second user within the application process;
identifying the annotation based on the one or more semantic tags indicating the data space and the application process; and
presenting the annotation to the second user.

7. A non-transitory medium storing processor-executable program code, the program code executable by a device to:
present, within an application process, data associated with a data space;
receive an annotation from a user during presentation of the data within the application process; and
store the annotation in association with one or more semantic tags indicating the data space and the application process.

8. A medium according to claim 7, the program code further executable by a device to:
index the annotation based on the one or more semantic tags.

9. A medium according to claim 7, the program code further executable by a device to:
present, within a second application process, second data associated with a second data space;
receive a second annotation from the user during presentation of the second data within the second application process;
store the second annotation in association with a second one or more semantic tags indicating the second data space and the second application process;
index the annotation based on the one or more semantic tags; and
index the second annotation based on the second one or more semantic tags.

10. A medium according to claim 7, the program code further executable by a device to:
present, within the application process, second data associated with a second data space;
receive a second annotation from the user during presentation of the second data within the application process;
store the second annotation in association with a second one or more semantic tags indicating the second data space and the application process;
index the annotation based on the one or more semantic tags; and
index the second annotation based on the second one or more semantic tags.

11. A medium according to claim 7, the program code further executable by a device to:
present, within a second application process, second data associated with the data space;
receive a second annotation from the user during presentation of the second data within the second application process;
store the second annotation in association with a second one or more semantic tags indicating the data space and the second application process;
index the annotation based on the one or more semantic tags; and
index the second annotation based on the second one or more semantic tags.

12. A medium according to claim 7, the program code further executable by a device to:
determine that second data associated with the data space is being presented to a second user within the application process;
identify the annotation based on the one or more semantic tags indicating the data space and the application process; and
present the annotation to the second user.

13. A system comprising:
a computing device comprising:
a memory system storing processor-executable program code; and
a processor to execute the processor-executable program code in order to cause the computing device to:
present, within an application process, data associated with a data space;
receive an annotation from a user during presentation of the data within the application process; and
store the annotation in association with one or more semantic tags indicating the data space and the application process.

14. A system according to claim 13, the processor to further execute the processor-executable program code in order to cause the computing device to:
index the annotation based on the one or more semantic tags.

15. A system according to claim 13, the processor to further execute the processor-executable program code in order to cause the computing device to:
present, within a second application process, second data associated with a second data space;
receive a second annotation from the user during presentation of the second data within the second application process;
store the second annotation in association with a second one or more semantic tags indicating the second data space and the second application process;
index the annotation based on the one or more semantic tags; and
index the second annotation based on the second one or more semantic tags.

16. A system according to claim 13, the processor to further execute the processor-executable program code in order to cause the computing device to:
present, within the application process, second data associated with a second data space;
receive a second annotation from the user during presentation of the second data within the application process;
store the second annotation in association with a second one or more semantic tags indicating the second data space and the application process;
index the annotation based on the one or more semantic tags; and
index the second annotation based on the second one or more semantic tags.

17. A system according to claim 13, the processor to further execute the processor-executable program code in order to cause the computing device to:
present, within a second application process, second data associated with the data space;
receive a second annotation from the user during presentation of the second data within the second application process;
store the second annotation in association with a second one or more semantic tags indicating the data space and the second application process;
index the annotation based on the one or more semantic tags; and
index the second annotation based on the second one or more semantic tags.

18. A system according to claim 13, the processor to further execute the processor-executable program code in order to cause the computing device to:
determine that second data associated with the data space is being presented to a second user within the application process;
identify the annotation based on the one or more semantic tags indicating the data space and the application process; and
present the annotation to the second user.
